(19) United States
(12) Patent Application Publication
(10) Pub. No.: US 2012/0154225 A1
(43) Pub. Date: Jun. 21, 2012

(54) WIRELESS COMMUNICATION DEVICE

(75) Inventor: Masaru KANAZAWA, Kawasaki (JP)

(73) Assignee: FUJITSU LIMITED, Kawasaki-shi (JP)

(21) Appl. No.: 13/299,491

(22) Filed: Nov. 18, 2011

(30) Foreign Application Priority Data
Dec. 21, 2010 (JP) 2010-285129

(51) Int. Cl. H01Q 1/24

(52) U.S. Cl. 343/702

(57) ABSTRACT

A wireless communication device includes: a first case having an antenna; and a second case connected to the first case, and having a first conductor at a position that is opposite to the antenna when the first case and the second case overlay each other, a second conductor at a position different from the position at which the first conductor is disposed, and a switch that switches an electrical connection state of the first conductor and the second conductor, wherein the switch switches the electrical connection state to disconnect state when the switch detects that the first case and the second case overlay each other.

### CROSS-REFERENCE TO RELATED APPLICATION

This application is based upon and claims the benefit of priority from the prior Japanese Patent Application No. 2010-285129 filed on Dec. 21, 2010, the entire contents of which are incorporated herein by reference.

### FIELD

The embodiments discussed herein are related to a wireless communication device that has an antenna in its case.

### BACKGROUND

To meet demands for portability and ease of operation, a mobile terminal device such as a mobile telephone uses a so-called folding structure in which divided cases are mutually connected by a hinge so as to openable and closable. The antenna characteristics of an antenna mounted in this type of mobile terminal device are important parameters in maintaining stable communication characteristics and assuring other communication quality.

As for an antenna mounted in a mobile communication device, a communication terminal in which two cases each have a conductor is disclosed, the conductors of the two cases being capacitively, inductively, or conductively coupled to each other.

The antenna in the communication terminal described in, for example, Japanese Laid-open Patent Publication No. 2004-134975 is assumed to be pulled out when the antenna is used. With recent communication terminals, however, built-in antennas are mainly used to meet a demand for small cases.

FIGS. 1A and 1B illustrate the principle of operation used when the technology described in Japanese Laid-open Patent Publication No. 2004-134975 is applied to a folding-type mobile telephone having a built-in antenna. FIG. 1A is a side view when the cases of this type of folding-type mobile telephone are open. With a mobile terminal device 2, which is an exemplary folding-type mobile telephone, a fixed part (case on the keyboard side) 4 and a movable part (case on the display side) 6 are mutually connected by a hinge 8 so as to be openable and closable.

In FIG. 1B, the folding-type mobile telephone is represented with an antenna circuit. In an antenna operation with the cases open, a metal or a material including a metal in the fixed part 4 forms a first antenna element 40, and a metal or a material including a metal in the movable part 6 forms a second antenna element 60. A built-in antenna 16 operates as a resonator. The first antenna element 40 and second antenna element 60 resonate with the built-in antenna 16. For functional reasons for the mobile terminal device 2, effects from the hand, head, and other regions of a person are avoided to reduce deterioration in the antenna characteristics by placing the built-in antenna 16 in the vicinity of the hinge 8, which is placed in a position distant from the hand and head. To cause resonance, in general, the first antenna element 40 and second antenna element 60 each have an electrical length of λ/4 to match the frequency band used in communication, forming a dipole antenna that has an electrical length of about λ/2 as the entire device length with the cases open. As illustrated by the arrows in FIG. 1B, a case current I (high-frequency current) flows in the first antenna element 40 and second antenna element 60. The larger the case current is, the better the antenna is.

Although, the antenna elements of the folding-type mobile telephone illustrated in FIGS. 1A and 1B are formed with the entire metal members included in the cases, FIGS. 2A and 2B illustrate an example in which ground layers on circuit boards in a folding-type mobile telephone are used as antenna elements. FIG. 2A illustrates a state in which the cases are open. A first ground layer 44 is formed on a first circuit board 42 in the fixed part 4. However, the first ground layer 44 is not present in an area, on the first circuit board 42, that is close to the hinge 8. Instead, in this area, a built-in antenna 16 is connected through a feeding point 18. The area is referred to as an antenna area X1, as illustrated in FIG. 2B. In the movable part 6 as well, a second ground layer 64 is formed on a second circuit board 62. The second ground layer 64 is capacitively coupled to the built-in antenna 16. A combination of the first ground layer 44 and second ground layer 64 forms an antenna element.

When the cases are closed as illustrated in FIG. 2B, however, the antenna area X1, in which the built-in antenna 16 is disposed, overlaps part of the second ground layer 64. Then, the second ground layer 64 shields radio waves directed to the built-in antenna 16, and the built-in antenna 16 and second ground layer 64 are capacitively coupled to each other. As a result, electric power to be radiated from the antenna flows into ground through the second ground layer 64. This is problematic in that electric power to be radiated from the antenna is lost and the antenna characteristics are deteriorated.

### SUMMARY

According to an aspect of the embodiment, a wireless communication device includes: a first case having an antenna; and a second case connected to the first case, and having a first conductor at a position that is opposite to the antenna when the first case and the second case overlay each other, a second conductor at a position different from the position at which the first conductor is disposed, and a switch that switches an electrical connection state of the first conductor and the second conductor, wherein the switch switches the electrical connection state to disconnect state when the switch detects that the first case and the second case overlay each other.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B illustrate the principle of operation of an antenna of a general folding-type mobile telephone.

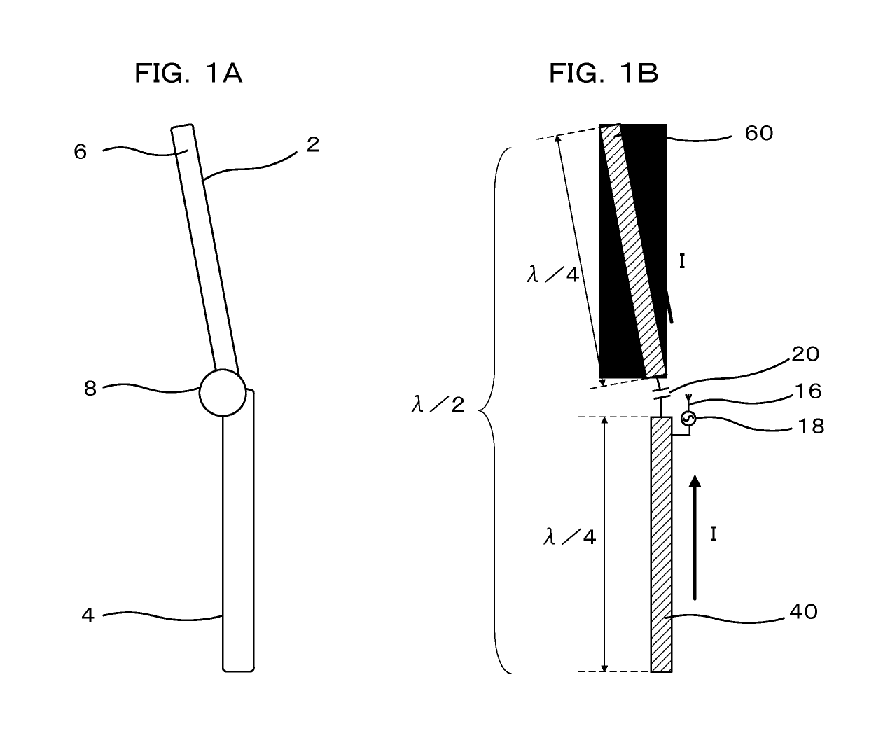

FIGS. 2A and 2B illustrate an example in which ground layers on circuit boards in a mobile telephone are used as antenna elements.

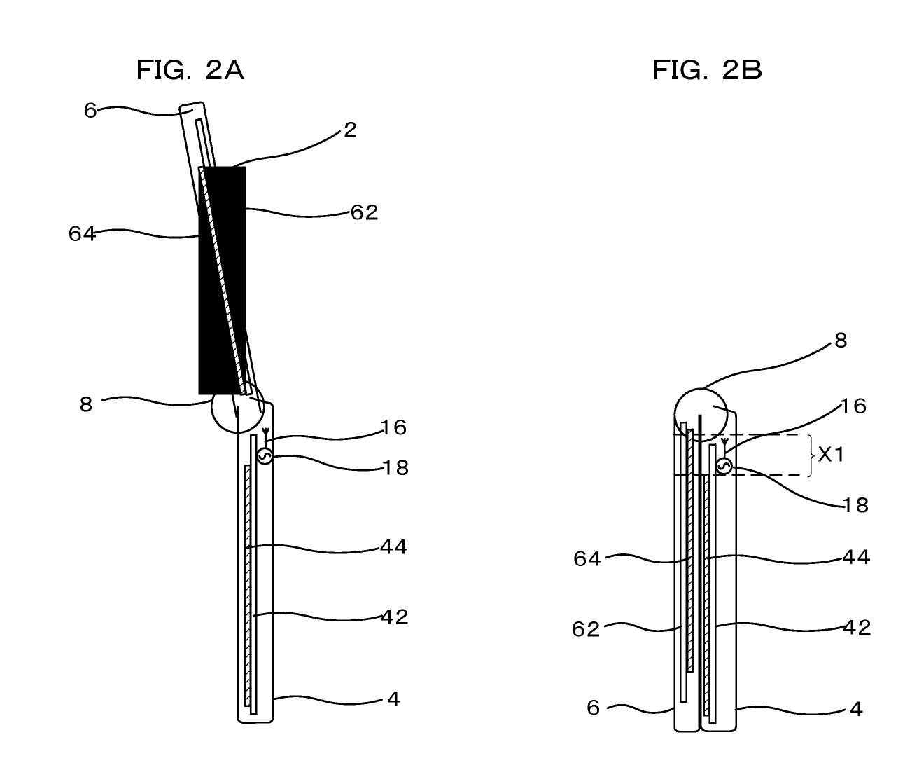

FIGS. 3A and 3B conceptually illustrate the internal structure of a folding-type mobile telephone to which the technology in this disclosure is applied.

FIGS. 4A and 4B also conceptually illustrate the internal structure of a folding-type mobile telephone to which the technology in this disclosure is applied.

FIGS. 5A and 5B illustrate an exemplary switch circuit.

FIGS. 6A and 6B illustrate a relationship between switch operations and the open and closed states of cases.

FIGS. 7A and 7B illustrate a relationship between antenna states and the open and closed states of the cases.

### DESCRIPTION OF EMBODIMENTS

A preferred embodiment of the technology in this disclosure will be described in detail with reference to the attached drawings.

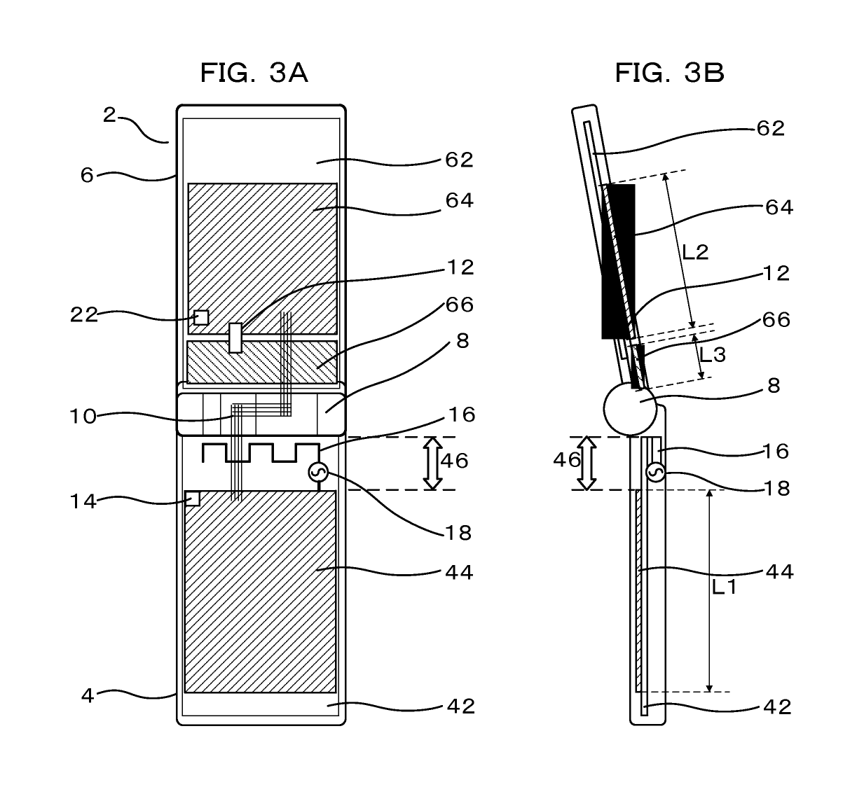

FIGS. 3A and 3B illustrate the structure of a folding-type mobile telephone to which the technology in this disclosure is applied. Specifically, FIGS. 3A and 3B conceptually illustrate the internal structure of a folding-type mobile telephone with its cases open. A mobile terminal device 2 is formed by connecting a fixed part (case on a keyboard side) 4 and a movable part (case on a display side) 6 are mutually connected by a hinge 8 so as to be openable and closable. A first circuit board 42 included in the fixed part 4 and a second circuit board 62 included in the movable part 6 are mutually connected by a flexible cable 10 passing through the hinge 8. The flexible cable 10 transfers control signals and other data between the first circuit board 42 and the second circuit board 62. The fixed part 4 has a sensor 14 at a position opposite to the movable part 6. The movable part 6 has a magnet 22 at a position opposite to the sensor 14. The sensor 14, which is a magneto-resistive (MR) sensor or another type of sensor that senses magnetism, is used to sense the open and closed states of the cases. The sensor 14 and magnet 22 may be a sensor and magnet that are widely used to control electric power to the display part of a general folding-type mobile telephone. The sensor 14 is disposed at a position at which the distance from the hinge 8 to the sensor 14 is almost the same as the distance from the hinge 8 to the magnet 22, and the magnetism from the magnet 22 to the sensor 14 changes when the cases are opened and closed. Control signals sent from the sensor 14 are transferred to a switch 12 provided on the second circuit board 62 through the first circuit board 42 in the fixed part 4, the flexible cable 10, and the second circuit board 62 in the movable part 6. The sensor 14 may be disposed on the second circuit board 62 in the movable part 6, and the magnet 22 may be disposed at a position, opposite to the movable part 6, on the fixed part 4.

A first ground layer 44, which has a thickness of, for example, about 1 mm or less, is provided on the first circuit board 42 in the fixed part 4, at a position at which the first ground layer 44 does not structurally interfere with operation keys, a microphone, and other constituent components included in the fixed part 4. Although, in this embodiment, the first ground layer 44 is disposed on the first circuit board 42, this is not a limitation. The first ground layer 44 may be a metal pattern or metal foil provided in the first circuit board 42 or may be formed with all metals included in the fixed part 4, including the cases and the parts.

The first ground layer 44 is not present in an area, on the first circuit board 42, that is close to the hinge 8. Instead, in this area, a built-in antenna 16 is connected through a feeding point 18 on a surface of the first circuit board 42, the surface being opposite to the surface on which the first ground layer 44 is formed. The built-in antenna 16 is a meandering or linear antenna with an electrical length of λ/4, which is one-fourth of the wavelength λ of a desired frequency f. An end of the feeding point 18 is connected to a wireless signal processing circuit provided on the first circuit board 42 through an impedance matching circuit (not illustrated). This area, which excludes the first ground layer 44 and extends from the built-in antenna 16 to the impedance matching circuit, is referred to as an antenna area 46.

A second ground layer (conductor) 64 is formed in an area, distant from the hinge 8, on the second circuit board 62 in the movable part 6. A display control circuit, a speaker control circuit, and the like are mounted on a second circuit board 62, on which the second ground layer 64 is formed. A conductive layer 66, made of a conductor, is formed in an area, close to the hinge 8, on the second circuit board 62. There is no circuit or the like in the area, on the second circuit board 62, on which the conductive layer 66 is formed. The second ground layer 64 and conductive layer 66, each having a thickness of, for example, about 1 mm, are disposed in the thin movable part 6 having a thickness of, for example, about 6 mm, at positions at which the second ground layer 64 and conductive layer 66 do not interfere with a speaker, display elements, and other constituent components therein. Alternatively, the second ground layer 64 and conductive layer 66 may be metal patterns provided on or in the second circuit board 62.

As illustrated in FIG. 3B, the electrical length L1 of the first ground layer 44 is λ/4 with respect to the frequency band used in communication. The total of the electrical length L2 of the second ground layer 64 and the electrical length L3 of the conductive layer 66 is λ/4 with respect to the frequency band, which is the same value as the electrical length L1.

The switch 12 is disposed, on the second circuit board 62, on the boundary between the second ground layer 64 and the conductive layer 66. A terminal at an end of the switch 12 is connected to the second ground layer 64, and a terminal at another end is connected to the conductive layer 66. The switch 12 is structured as a P-intrinsic-N (PIN) diode, a single-pole/double-throw (SPDT) switch, or the like. The switch 12 selectively connects and disconnects the conductive layer 66 to and from the second ground layer 64.

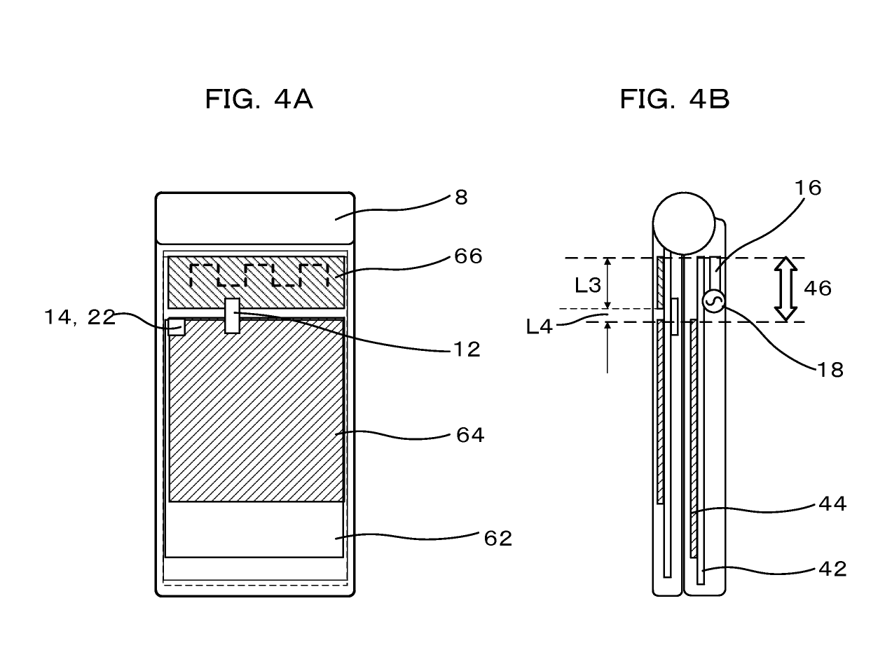

FIGS. 4A and 4B also illustrate the structure of a folding-type mobile telephone to which the technology in this disclosure is applied. Specifically, FIGS. 4A and 4B conceptually illustrate the internal structure of a folding-type mobile telephone with its cases closed. As illustrated in FIGS. 4A and 4B, when the cases are closed, the conductive layer 66 is positioned in the vicinity of the built-in antenna 16 and parallel to it. The total of the length L3 of the conductive layer 66 and a spacing L4 between the conductive layer 66 and the second ground layer 64 is equal to the length of the antenna area 46.

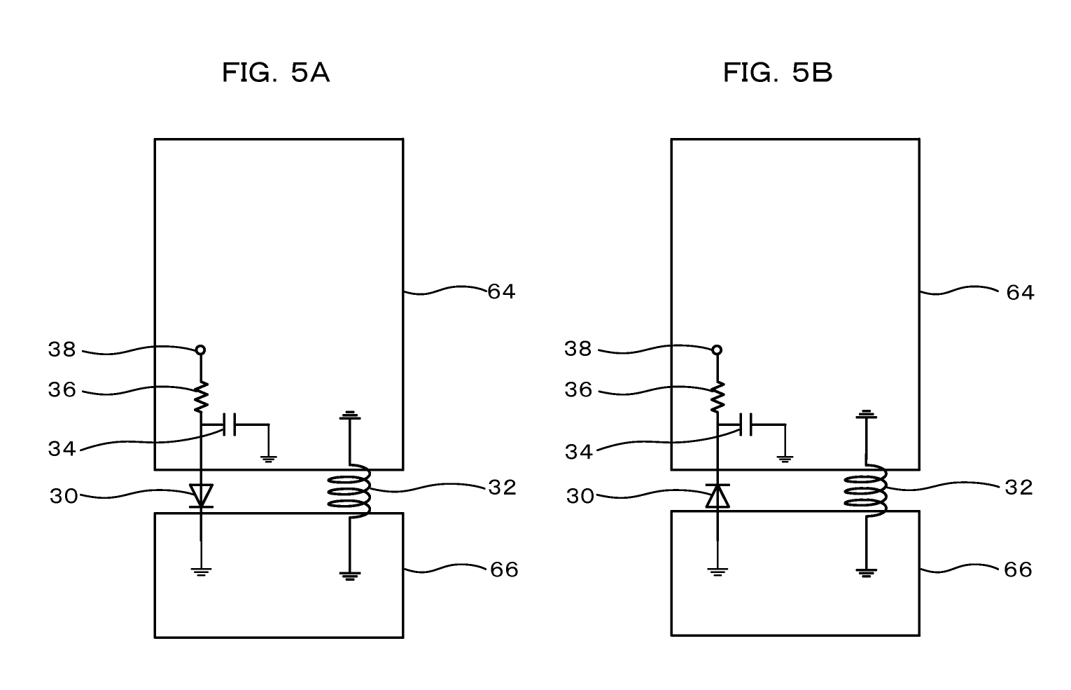

FIGS. 5A and 5B illustrate an example of a circuit that forms the switch 12 with a PIN diode. The switch 12 includes a PIN diode 30, a choke coil 32, a DC-cut capacitor 34, and a resistor 36. FIG. 5A illustrates an example in which the PIN diode 30 is oriented so that its anode faces the second ground layer 64 and its cathode faces the conductive layer 66. An end of the resistor 36 is connected to the anode of the PIN diode 30. Control signals are input from the sensor 14 to a terminal 38 provided at the other end of the resistor 36. The cathode of the PIN diode 30 is connected to the conductive layer 66. When there is no control signal from the sensor 14, the PIN diode 30 is at a high impedance, preventing a current from flowing between the second ground layer 64 and the conductive layer 66. When an active ON signal with a positive potential is input from the sensor 14 into the anode through the resistor 36, the PIN diode 30 is forward biased, causing a current to flow into the second ground layer 64 through the PIN diode 30 and choke coil 32. The conductive layer 66 and second ground layer 64 are thereby electrically connected to each other. The DC-cut capacitor 34 prevents the current directed to the PIN diode 30 from flowing into the second ground layer 64.

FIG. 5B illustrates an example in which the PIN diode 30 is oriented so that its anode faces the conductive layer 66 and its cathode faces the second ground layer 64. An end of the resistor 36 is connected to the cathode of the PIN diode 30. Control signals are input from the sensor 14 to the terminal 38 at the other end of the resistor 36. The anode is connected to the conductive layer 66. When there is no control signal from the sensor 14, the PIN diode 30 is at a high impedance, preventing a current from flowing between the second ground layer 64 and the conductive layer 66. When an active ON signal with a negative potential is input from the sensor 14 into the cathode through the resistor 36, the PIN diode 30 is forward biased, causing a current to flow from the second ground layer 64 into the choke coil 32 and PIN diode 30. The conductive layer 66 and second ground layer 64 are thereby electrically connected to each other. The structure of the switch 12 is not limited to the structure illustrated in FIGS. 5A and 5B. The switch 12 may be an electronic switch, a mechanical switch, or any other type of switch that is adaptable to high frequencies.

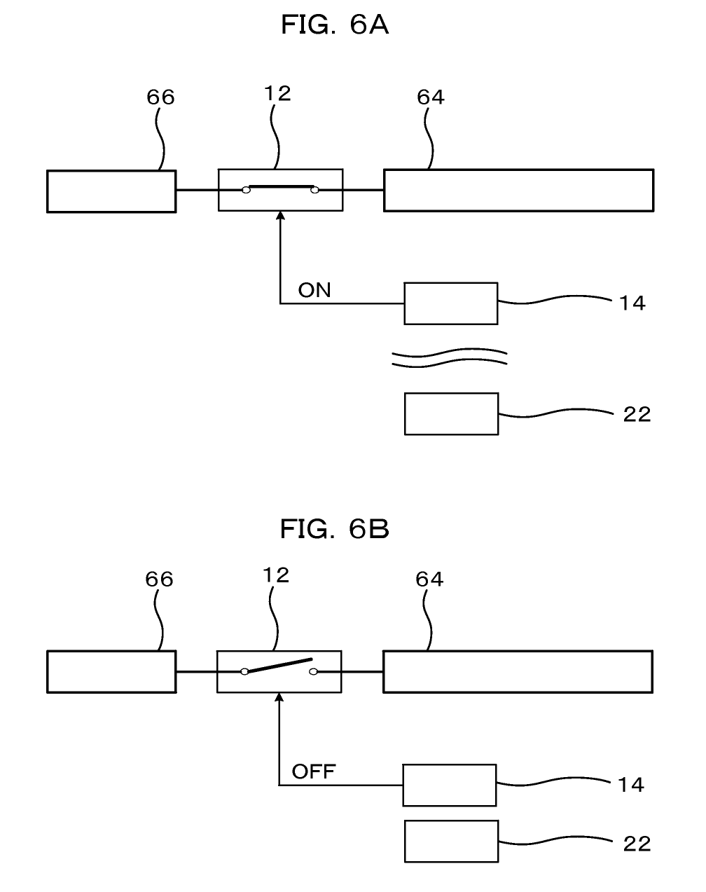

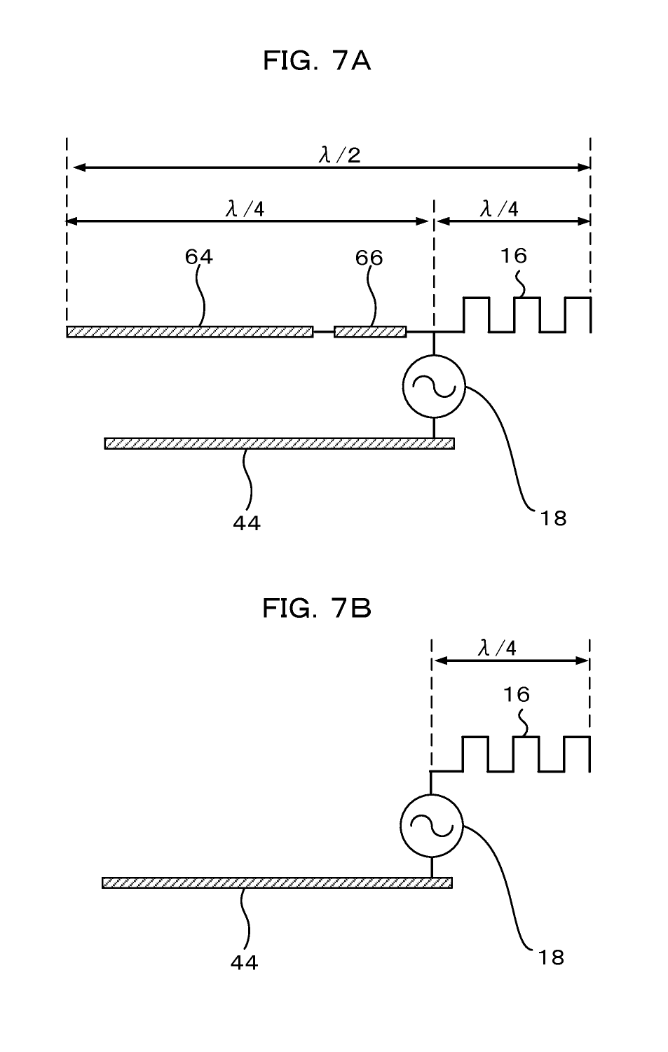

Next, a switchover of an antenna operation will be described with reference to FIGS. 6A, 6B, 7A, and 7B. FIGS. 6A and 6B illustrate a relationship between switch operations and the open and closed states of the cases. FIGS. 7A and 7B illustrate a relationship between antenna states and the open and closed states of the cases.

FIG. 6A is a block diagram illustrating the state of the switch 12 and sensor 14 when the fixed part 4 and movable part 6 of the mobile terminal device 2 are open as illustrated in FIGS. 3A and 3B. Since, in this state, the sensor 14 and magnet 22 are placed at a distance from each other, the sensor 14 may not sense the magnetism of the magnet 22. Accordingly, the sensor 14 sends an ON signal by which the switch 12 is placed in a closed state, and the second ground layer 64 and conductive layer 66 are thereby electrically short-circuited. As a result, as illustrated in FIG. 7A, the second ground layer 64 and conductive layer 66 are capacitively coupled to the built-in antenna 16 and function as a resonator with an electrical length of λ/4, generating a resonant state with an electrical length of λ/2.

FIG. 6B is a block diagram illustrating the state of the switch 12 and sensor 14 when the fixed part 4 and movable part 6 of the mobile terminal device 2 are closed as illustrated in FIGS. 4A and 4B. Since, in this state, the sensor 14 and magnet 22 are placed close to each other, the sensor 14 senses the magnetism of the magnet 22. Accordingly, the sensor 14 sends an OFF signal by which the switch 12 is placed in an open state, and the second ground layer 64 and conductive layer 66 are thereby insulated from each other. That is, the conductive layer 66 present in the antenna area 46 illustrated in FIG. 4B is placed in a floating state. As a result, as illustrated in FIG. 7B, only the built-in antenna 16 with an electrical length of λ/4, which is connected to the feeding point 18, functions as an antenna element, forming a monopole antenna with an electrical length of λ/4.

If, for example, the switch 12 is not provided, even when the fixed part 4 and movable part 6 of the mobile terminal device 2 are closed, the second ground layer 64 and conductive layer 66 remain electrically connected to each other. In this case, not only the second ground layer 64 and conductive layer 66 shield radio waves directed to the built-in antenna 16, but also the built-in antenna 16 and conductive layer 66 are capacitively coupled to each other. As a result, electric power to be radiated from the antenna flows to the ground side of the second ground layer 64 through the conductive layer 66. This is problematic in that electric power to be radiated from the antenna is lost and the antenna characteristics are deteriorated.

In this embodiment, however, the conductive layer 66 is placed in the floating state by the switch 12. This prevents the conductive layer 66 from being capacitively coupled to the built-in antenna 16 and the power to be radiated from the antenna does not flow into ground through the conductive layer 66, reducing effects on the antenna characteristics. Although the conductive layer 66 is made of a metal, its electrical length is extremely shorter than λ/2, which is a resonance condition when the cases are closed, so radiation from the built-in antenna 16 is not interfered.

This completes the detailed description of the preferred embodiment of this disclosure. This disclosure is not limited to a particular embodiment, but various modifications and variations of this disclosure are possible within an outline of this disclosure described in claims. Although, for example, an example of a folding-type mobile telephone has been described in the above embodiment, the structure described above may also be applied to slide mobile telephones, rotary mobile telephones, split-type mobile telephones, and any other types of mobile telephones that have a plurality of cases.

The wireless communication device is not also limited to a mobile telephone. For example, the wireless communication device may be a PDA, notebook personal computer, or small-sized game machine that has an opening/closing mechanism.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A wireless communication device comprising:
a first case having an antenna; and
a second case connected to the first case, and having a first conductor at a position that is opposite to the antenna when the first case and the second case overlay each other, a second conductor at a position different from the position at which the first conductor is disposed, and a switch that switches an electrical connection state of the first conductor and the second conductor,
wherein the switch switches the electrical connection state to disconnect state when the switch detects that the first case and the second case overlay each other.

2. The wireless communication device according to claim 1, wherein:
the first case has a third conductor; and
the antenna, the first conductor, the second conductor, and the third conductor are mutually capacitively coupled when the first case and the second case are not overlay each other.
